(19) United States
(12) Patent Application Publication
(10) Pub. No.: US 2011/0292161 A1
(43) Pub. Date: Dec. 1, 2011

(54) Systems And Methods For Scalable Video Communication Using Multiple Cameras And Multiple Monitors

(75) Inventors: Ran Sharon, Tenafly, NJ (US); Roi Sasson, New York, NY (US); Jonathan Steer, Nashua, NH (US); Alexandros Eleftheriadis, Tenafly, NJ (US)

(73) Assignee: VIDYO, INC., Dallas, TX (US)

(21) Appl. No.: 13/115,960

(22) Filed: May 25, 2011

Related U.S. Application Data
(60) Provisional application No. 61/347,994, filed on May 25, 2010.

(51) Int. Cl. H04N 7/15

(52) U.S. Cl. 348/14.07; 348/E07.083

(57) ABSTRACT

Systems and methods for performing videoconferencing using endpoints with multiple monitors and multiple cameras are disclosed herein. These endpoints are comprised of, where each node is comprised of a control unit and one or more node units, each connected to at least one monitor, camera, speaker, or microphone. Video is encoded using scalable coding, and endpoints are connected to each other over a network using an SVCS. Algorithms are described for layout management, tagging of individual streams, and use of tags for dynamic and prioritized layout management.

### CROSS-REFERENCE TO RELATED APPLICATIONS

This application claims priority to U.S. Provisional Application Ser. No. 61/347,994, filed May 25, 2010, which is incorporated by reference herein in its entirety.

### FIELD OF THE INVENTION

The disclosed subject matter relates to video communication systems, and particularly point-to-point or multi-point video communication systems in which one or more participants may have access to more than one camera and/or more than one display.

### BACKGROUND OF THE INVENTION

Video communication systems such as the ones used for videoconferencing often involve a single camera and a single display for each of the participants. This is typically the case when the system is hosted on a personal computer. High-end systems, intended for use in dedicated conferencing rooms, may feature multiple monitors. The 2^{nd} monitor is often dedicated to application sharing material (“content”). When no such content is used, one monitor may feature the loudest speaker whereas the other monitor shows some or all of the remaining participants.

Recently, there has been significant interest in so-called “telepresence” systems. These are systems that are intended to convey the sense of “being in the same room” as the remote participant(s). In order to accomplish this goal, these systems utilize multiple cameras as well as multiple displays. The displays and cameras are positioned at carefully calculated positions in order to be able to give a sense of eye-contact. Typical systems involve three displays—left, center, and right—although configurations with only two or more than three displays are also available.

The displays are situated in carefully selected positions in the conferencing room. Looking at each of the displays from any physical position on the conferencing room table is supposed to give the illusion that the remote participant is physically located in the room. This is accomplished by matching the exact size of the person as displayed to the expected physical size that the subject would have if he or she were actually present in the perceived position within the room. High-end systems go as far as matching the furniture, room colors, and lighting, to further enhance the life-like experience.

In order to be effective, telepresence systems must offer very high resolution and operate with very low latency. For example, these systems can operate at high definition (HD) 1080p/30 resolutions, i.e., 1080 horizontal lines progressive at 30 frames per second. To eliminate latency and packet loss, they also use dedicated multi-megabit networks and typically operate in point-to-point or switched configurations (i.e., they avoid transcoding).

Traditional video conferencing systems assume that each endpoint is equipped with a single camera, although they can be equipped with several displays. For example, the commercially available VidyoRoom HD-220 system, produced by Vidyo, Inc., is equipped with one camera and two monitors. The dual monitor configuration can be used in several different ways. For example, the active speaker can be displayed in the primary monitor, with the other participants shown in the second monitor in a matrix of smaller windows. The matrix layout is referred to as “continuous presence”, since participants are continuously present on the screen rather than being switched in and out depending on who is the active speaker. An alternative way is to use the second monitor to display content (e.g., a slide presentation from a computer) and the primary monitor to show the participants. The primary monitor then is treated as with a single-monitor system.

Telepresence systems that feature multiple cameras are designed so that each camera is assigned to its own codec. A system with three cameras and three screens would then use three separate codecs to perform encoding and decoding at each endpoint. These codecs would make connections to three counterpart codecs on the remote site, using proprietary signaling or proprietary signaling extensions to existing protocols.

The three codecs are typically identified as “left,” “right,” and “center.” In this document such positional references are made from the perspective of a user of the system; left, in this context, is the left-hand side of a user that is sitting in front of the camera(s) and is using the system. Audio is typically stereo, and can be handled through the center codec. In addition to the three video screens, telepresence systems typically include a fourth screen to display computer-related content such as presentations. This is referred to as the “content” or “data” stream.

Telepresence systems pose unique challenges compared with traditional videoconferencing systems. A key challenge is the fact that such systems must be able to handle multiple video streams. A typical videoconferencing system only handles a single video stream, and optionally an additional “data” stream for content. Even when multiple participants are present, the Multipoint Control Unit (MCU) is responsible for compositing the multiple participants in a single frame and transmitting the encoded frame to the receiving endpoint. Existing systems today address the need for multiple stream support in two different ways. One way is to establish as many connections as there are video cameras. This means that, for a three camera systems, three separate connections have to be established. Note that mechanisms have to be provided to properly treat these separate streams as a unit, i.e., as coming from the same location.

A second way is to use proprietary extensions to existing signaling protocols, or use new protocols, such as the Telepresence Interoperability Protocol (TIP). TIP was originally designed by Cisco Systems, Inc., and is currently managed by the International Multimedia Telecommunications Consortium (IMTC); the specification can be obtained from IMTC at the address 2400 Camino Ramon, Suite 375, San Ramon, Calif. 94583, USA or from the web site http://www.imtc.org/tip. TIP was designed to allow multiple audio and video streams to be transported over a single RTP (Real-Time Protocol, RFC 3550) connection. TIP enables the multiplexing of up to four video or audio streams in the same RTP session, using proprietary RTCP (Real-Time Control Protocol, defined in RFC 3550 as part of RTP) messages.

A significant difficulty in designing and implementing telepresence systems, is multipoint operation and integration with non-telepresence systems. Traditional multipoint systems utilize MCUs, either in switching or transcoding configurations. The transcoding configuration introduces significant delay due to cascaded decoding and encoding, in addition to quality loss, and is thus problematic for the high-quality experience expected of a telepresence system. Switching, on the other hand, can become awkward, particularly when used between systems with a different number of screens.

Integration with non-telepresence systems, such as single-screen room systems, computer desktop systems, or mobile systems (on tablets or phones), is similarly problematic. In fact, existing telepresence systems that are based on legacy videoconferencing equipment do not support the presence of a low-end device without transcoding through an MCU.

Scalable video coding (‘SVC’), an extension of the well-known video coding standard H.264 that is already used in most digital video applications, is a video coding technique that has proven to be very effective in interactive video communication. The bitstream syntax and decoding process are formally specified in ITU-T Recommendation H.264, and particularly Annex G. ITU-T Rec. H.264, incorporated herein by reference in its entirety, can be obtained from the International telecommunications Union, Place de Nations, 1120 Geneva, Switzerland, or from the web site www.itu.int. The packetization of SVC for transport over RTP is defined in RFC 6190, “RTP payload format for Scalable Video Coding,” incorporated herein by reference in its entirety, which is available from the Internet Engineering Task Force (IETF) at the web site http://www.ietf.org.

Scalable video and audio coding has been beneficially used in video and audio communication using the so-called Scalable Video Coding Server (SVCS) architecture. The SVCS is a type of video and audio communication server and is described in commonly assigned U.S. Pat. No. 7,593,032, “System and Method for a Conference Server Architecture for Low Delay and Distributed Conferencing Applications”, as well as commonly assigned International Patent Application No. PCT/US06/62569, “System and Method for Videoconferencing using Scalable Video Coding and Compositing Scalable Video Servers,” both incorporated herein by reference in their entirety. It provides an architecture that allows for very high quality video communication with high robustness and low delay.

Commonly assigned International Patent Application Nos. PCT/US06/061815, “Systems and methods for error resilience and random access in video communication systems,” PCT/US07/63335, “System and method for providing error resilience, random access, and rate control in scalable video communications,” and PCT/US08/50640, “Improved systems and methods for error resilience in video communication systems,” all incorporated herein by reference in their entirety, further describe mechanisms through which a number of features such as error resilience and rate control are provided through the use of the SVCS architecture.

In one form, the SVCS operation includes receiving scalable video from a transmitting endpoint and selectively forwarding layers of that video to the receiving participant(s). In a multipoint configuration, and contrary to an MCU, the SVCS performs no decoding/composition/re-encoding. Instead, all appropriate layers from all video streams are sent to each receiving endpoint by the SVCS, and each receiving endpoint is itself responsible for performing the composition for final display. Note that this means that, in the SVCS system architecture, all endpoints have to have multiple stream support, because the video from each transmitting endpoint is transmitted as a separate stream to the receiving endpoint(s). Of course, the different streams can be transmitted over the same RTP session (i.e., multiplexed), but the endpoint must be configured to receive multiple video streams, decode, and compose them for display. This is a very important advantage for SVC/SVCS-based systems in terms of supporting telepresence-type operation. In fact, the architecture lends itself to a much more general treatment, where telepresence is simply a special case of a multiple camera/multiple monitor architecture.

Consideration now is being given to developing architectures and systems for video communication using devices that feature multiple cameras and multiple monitors, that take advantage of the capabilities made available by scalable video coding and SVCSs.

### SUMMARY

Systems and methods for performing videoconferencing using endpoints with multiple monitors and multiple cameras are disclosed herein.

In some embodiments, multimonitor/multicamera endpoints are comprised of nodes, where each node is comprised of a control unit and one or more node units, each connected to at least one monitor, camera, speaker, or microphone. Video is encoded using scalable coding, and endpoints are connected to each other over a network using an SVCS. In one embodiment, media from node units does not flow through the control unit. In another embodiment, media from node units flows through the control unit.

In one embodiment, the control unit assigns particular monitor layouts to each of the nodes, and selectively forwards layers from- and to- each endpoint. The control unit can dynamically change the layout of each monitor depending on system events.

In one embodiment of the disclosed subject matter, media streams are tagged with attributes such as loudness of audio, so that a control unit can apply prioritized stream selection in its assignment algorithm. Additional attributes can include linking and geolocation information. Stream allocation can take into account performance limits such as maximum pixel rate or maximum bit rate for a particular node.

### BRIEF DESCRIPTION OF THE DRAWINGS

FIG. 1 illustrates an exemplary telepresence system (prior art);

FIG. 2 illustrates the architecture of an exemplary commercial telepresence system (prior art);

FIG. 3 depicts multiple exemplary screen placement configurations in accordance with some embodiments of the disclosed subject matter;

FIG. 4 depicts an exemplary spatial and temporal prediction coding structure for SVC encoding;

FIG. 5 depicts an exemplary SVCS architecture;

FIG. 6 depicts the multimonitor/multicamera endpoint architecture, in accordance with some embodiments of the disclosed subject matter;

FIG. 7 depicts an exemplary multimonitor/multicamera system in accordance with some embodiments of the disclosed subject matter;

FIG. 8 depicts the monitor model used for layout organization, comprising a hierarchy of display/window/tile, in accordance with some embodiments of the disclosed subject matter;

FIG. 9 lists exemplary messages of a video decoder service interface for the Node Unit Protocol, in accordance with some embodiments of the disclosed subject matter;

FIG. 10 lists exemplary messages of a video decoder event interface for the Node Unit Protocol, in accordance with some embodiments of the disclosed subject matter;

FIG. 11 illustrates exemplary telepresence layout multimonitor adaptations, in accordance with some embodiments of the disclosed subject matter;

FIG. 12 depicts exemplary multimonitor system single-monitor layouts, in accordance with some embodiments of the disclosed subject matter;

FIG. 13 depicts exemplary multimonitor system layouts, in accordance with some embodiments of the disclosed subject matter;

FIG. 14 depicts exemplary multimonitor layout transitions, in accordance with some embodiments of the disclosed subject matter; and

FIG. 15 depicts an exemplary computer system.

Throughout the figures the same reference numerals and characters, unless otherwise stated, are used to denote like features, elements, components or portions of the illustrated embodiments. Moreover, while the disclosed subject matter will now be described in detail with reference to the figures, it is done so in connection with the illustrative embodiments.

### DETAILED DESCRIPTION OF THE INVENTION

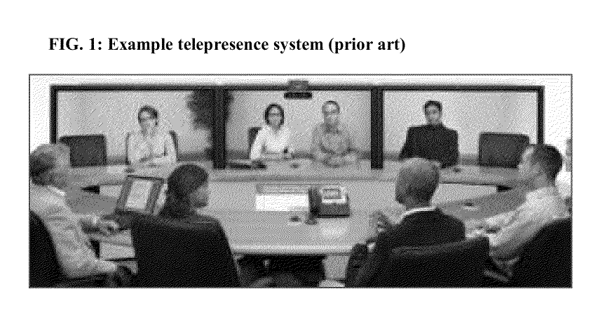

FIG. 1 depicts a commercially available telepresence conference room system. The room has a conference table that, in this case, sits four individuals. Across the table there is a configuration with three large-size monitors that each shows one or two participants. The sizing of the subjects and the positioning of the monitors is such that, for those sitting in the table, they appear to be sitting right across them on the other side of the table. This “illusion” is further enhanced by ensuring that the conference table and other furniture on the remote location(s) that are shown on the screens are similar, or even identical. The conference room is also equipped with a “content” display recessed in the center of the table.

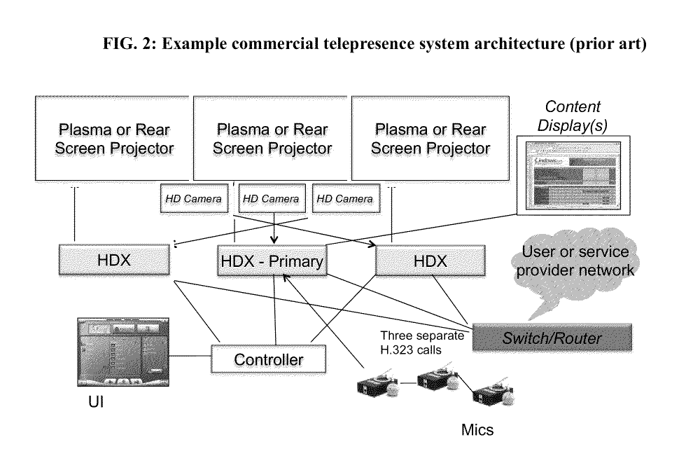

FIG. 2 depicts the architecture of a commercially available telepresence system such as the one shown in FIG. 1 (the Polycom TPX 306M). The system features three screens (plasma or rear screen projection) and three HD cameras. Each HD camera is paired with a codec which is provided by an HDX traditional (single-stream) videoconferencing system. One of the codecs is labeled as Primary. Notice the diagonal pairing of the HD cameras with the codecs. This is so that the correct viewpoint is offered to the viewer on the remote site.

The Primary codec is responsible for audio handling. The system here is shown as having multiple microphones, which are mixed into a single signal that is encoded by the primary codec. There is also a fourth screen to display content. The entire system is managed by a special device labeled as the Controller. In order to establish a connection with a remote site, this system performs three separate H.323 calls, one for each codec. This is because existing ITU-T standards do not allow the establishment of multi-camera calls. This architecture is typical of existing telepresence products that use standards-based signaling for session establishment and control. Use of the TIP protocol would allow system operation with a single connection, and would make possible up to 4 video streams and 4 audio streams to be carried over two RTP sessions (one for audio and one for video).

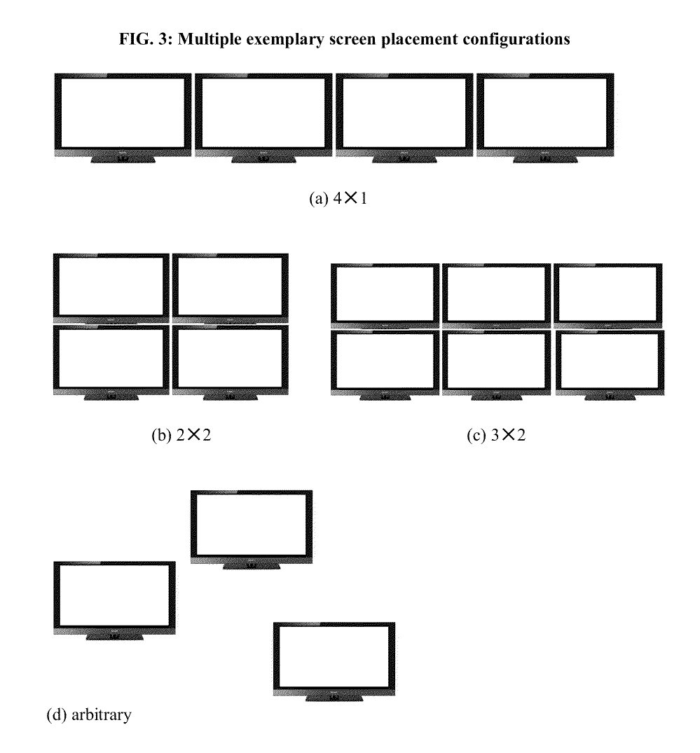

In embodiments of the disclosed subject matter, an endpoint is equipped with multiple monitors. The monitors can be positioned in a row, as with a telepresence system, but more generally they can have any number of different placement configurations. FIG. 3 shows exemplary placement configurations. FIG. 3(a) shows a 4-by-1 configuration (4 monitors in a single row), whereas (b) and (c) show 2-by-2 and 3-by-2 configurations, respectively. FIG. 3(d) shows a configuration where the monitors are placed in arbitrary locations. Furthermore, that the monitors do not even have to be on the same plane; for example, four monitors can be placed in the four walls of the room. Finally, although identical monitors are shown in all exemplary configurations of FIG. 3, completely arbitrary monitor sizes can be used.

In some embodiments of the disclosed subject matter the endpoint can be equipped with multiple cameras, which could be more or fewer than the number of monitors. The cameras can be located on the monitors (attached to them at the top), built inside the monitors (e.g., at the bezel, such as with the built-in camera of commercially available Apple Cinema displays), or they could be positioned in completely different locations.

In the following, the number of monitors associated with an endpoint will be denoted by M and the number of cameras associated with an endpoint will be denoted by C. Often a telepresence system is designed so that a set number of users is intended to be shown in each monitor, typically one or two. This number is herein indicated U. A system configuration can then be described by M/C/U; a 3/3/2 system then involves 3 monitors, 3 cameras, with 2 users intended to be shown in each of the monitors (and captured by each of the cameras). The system shown in FIG. 1 is a 3/3/2 system.

In all embodiments of the disclosed subject matter it is assumed that scalable video (and optionally audio) coding is used, following the H.264 SVC specification (previously cited). For audio it is assumed that the MPEG AAC-LD audio coding is used.

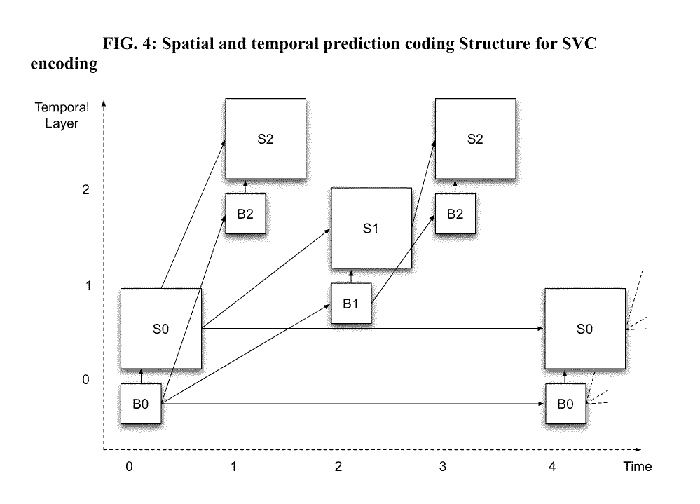

FIG. 4 depicts the spatial and temporal prediction coding structure typical in SVC encodings, and used in some embodiments of the disclosed subject matter, as described in U.S. Pat. No. 7,593,032 (previously cited). The figure shows three temporal layers (0 through 2) and two spatial layers (a base layer (‘B’) and a spatial enhancement layer (‘S’)). The arrows show the prediction paths (prediction dependencies). It is noted that the decoding of a particular temporal layer only requires information from the particular layer or lower layers. For example, decoding of B1 pictures requires information from B0 pictures only; specifically, it expressly does not require any B2 pictures. Similarly, for the spatial dimension, decoding the full resolution requires both the base and spatial enhancement layer, but decoding the lower resolution only requires the base layer information.

By selecting a subset of the layers, one can obtain a version of the original signal at different spatial and temporal resolutions. For example, taking only the B components (i.e., all B0, B1, and B2), one obtains the signal in full temporal resolution but low spatial resolution. Similarly, by taking the B0/S0 and B1/S1 components one obtains the signal at full resolution but at half the original frame rate.

The particular picture coding structure is just an example, and other structures can also be used as described in commonly assigned International Patent Application No. PCT/US06/028365, “System and method for scalable and low-delay videoconferencing using scalable video coding,” incorporated herein by reference in its entirety, or others, as is known to people skilled in the art.

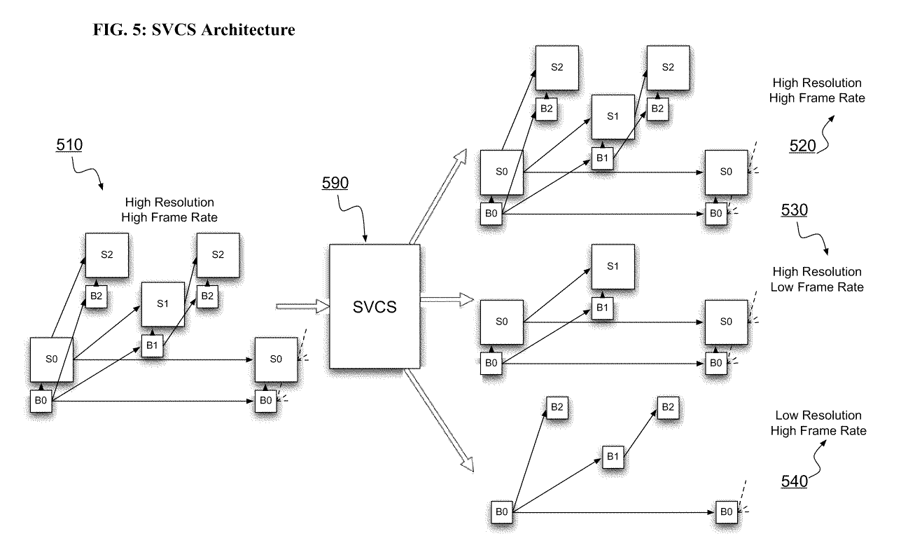

In embodiments of the disclosed subject matter, one or more SVCS servers can be used. The basic operation of the SVCS is described below with reference to FIG. 5. The figure shows an SVCS 590 that interconnects one transmitting endpoint 510 with three receiving endpoints (520, 530, 540). The transmitting endpoint 510 sends a full resolution signal—all 2 spatial layers and 3 temporal layers—to the SVCS 590. Receiving endpoint 520 supports high resolution/high frame rate signals, receiving endpoint 530 supports high resolution but low frame rate signals, and receiving endpoint 540 supports low resolution and low frame rate signals. The SVCS 590 then selectively forwards the appropriate subset of layers to each receiving endpoint, depending on its capabilities. For receiving endpoint 520 it forwards all layers; for receiving endpoint 530 it forwards full spatial resolution but at half the frame rate; finally, for receiving endpoint 540 it forwards the low spatial resolution but at the full frame rate.

As explained in detail in U.S. Pat. No. 7,593,032 (previously cited), the SVCS architecture has significant advantages compared to traditional switching and transcoding Multipoint Control Units (MCUs) for multipoint video and audio communication: there is very little delay (10-20 msec vs. 200 msec for an MCU), there is no transcoding loss, and rate matching and personalized layout operations become packet forwarding decisions (i.e., decisions on which packet should be forwarded to each of the receiving endpoints).

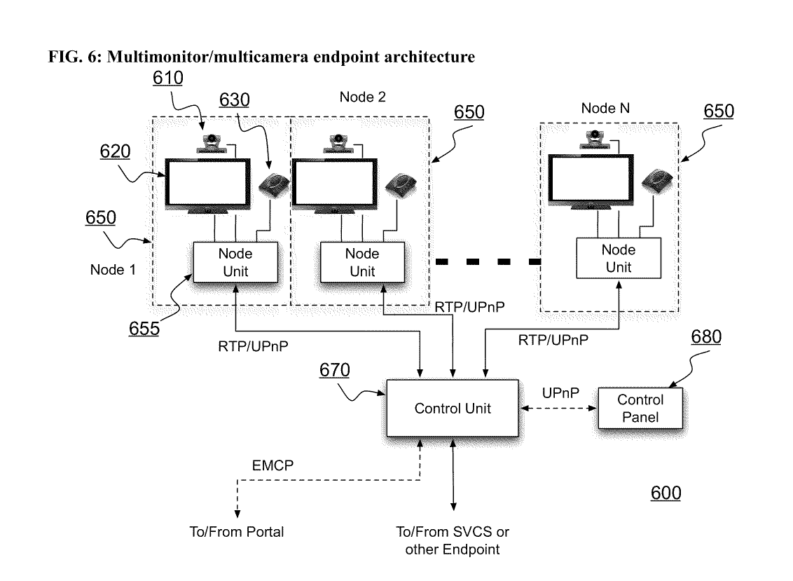

The architecture for multimonitor/multicamera support in an endpoint in one embodiment of the disclosed subject matter is shown in FIG. 6. The figure shows an endpoint 600 comprised of a Control Unit 670 and a set of Nodes 650. An endpoint can include any number of Nodes; in the figure N number of Nodes are shown. Each Node 650 consists of a Node Unit 655, which can be connected to a monitor, optionally a camera, and optionally to an audio device (mirophone, speaker, or a combination of the two, in either mono or stero). These are reffered to as ‘peripheral devices’ in the following.

FIG. 6 shows all Nodes 650 with Node Units 655 all connected to a Monitor 620, a Camera 610, and an Audio Device 630, but the presence of each is optional. At least one of the devices must be present in each of the nodes. Using N nodes, up to N cameras and up to N monitors can be used, and up to N sources of audio can be supported. Each peripheral device is connected to its associated Node Unit using an appropriate physical interface. In one embodiment of the disclosed subject matter, HDMI (High-Definition Multimedia Interface) can be used to connect the Monitor 620, HD-SDI (High Definition Serial Digital Interface, SMTPE 292M) can be used to connect a high-definition Camera 610, and USB 2.0 (Universal Serial Bus) can be used to connect the Audio Device 630.

It is possible that each Node 650 can be equipped with more than one Monitor 610, or support more than one Camera 630. These cases are treated in essentially the same way as the single camera/single monitor Node case, as it will be obvious to people skilled in the art. In the following, it is assumed that each Node 650 is equipped with a single monitor and camera, for simplicity of the presentation. Similarly, although FIG. 6 shows the various Node Units 655 as separate units on a network, it is of course possible that they are integrated into a single device, such as a single computer with multiple interfaces. Alternatively, the Endpoint 600 can be implemented in a blade server, in which case each Node Unit 655 could then be a blade in the said server.

In one embodiment of the disclosed subject matter, content can be generated and encoded by either a Node Unit 650 or a Control Unit 670. Content can be encoded using the same SVC algorithm that is used for regular video, albeit tuned in a different way (higher spatial resolution but lower frame rate). This allows content decoding by any video-capable Node Unit. The content generation could be performed either internally, by capturing the contents of a window on the host computer or its entire desktop, or by obtaining an external computer graphics signal (not shown in FIG. 6).

With continued reference to FIG. 6, in one embodiment of the disclosed subject matter the Nodes 650 are connected to the Control Unit 670 over an IP-based network using IEEE 802.3u (100BASE-TX over CATS copper cabling) or IEEE 802.11n (wireless—WiFi). The same network is also used to connect a Control Panel 680 to the Control Unit 670. In one embodiment of the disclosed subject matter the Control Panel 680 can be an Apple iPad tablet that connects over a wireless connection to the Control Unit 670. The Control Panel 680 runs an application that allows it to remotely control the functions of the Control Unit 670 and the Endpoint 600 in general. In an alternative embodiment of the disclosed subject matter the Control Panel 680 can perform its control functions by connecting to the Portal, described below. In one embodiment, access may be provided through a web interface so that any device with a web browser can be used to perform the Control Panel 680 functions.

A Node Unit 655 is a device that is capable of performing decoding of video if a monitor is present, encoding of video if a camera is present, encoding of audio if one or more microphones are present, and decoding of audio if one or more speakers are present. In one embodiment of the disclosed subject matter the Node Units 655 can be a general purpose personal computer with appropriate hardware interfaces for the peripheral devices, and running appropriate software to perform the Node Unit 655 functions described herein. The commercially available VidyoRoom HD-50 system from Vidyo, Inc., is a hardware device that features a general purpose personal computer equipped with appropriate interfaces to perform video encoding and decoding, as well as Speex Wideband audio, and can thus be used for this purpose.

It is also possible to create custom devices to perform the Node Unit 655 functions. For example, for Node Units without a camera, it is possible to produce very inexpensive devices. In fact, Node Unit capability could even be added to television sets that are equipped with hardware SVC decoders. Similarly, webcam manufacturers today are already designing devices that feature built-in SVC encoders; it is therefore straightforward to add network connectivity and the associated software to make them Node Units 655 offering camera (and microphone) functionality.

Similarly, it is possible for the Control Unit 670 to integrate at least one Node Unit 655, since it can have a monitor, camera, and speaker/microphone. One can equip a large room system such as the VidyoRoom HD-220, commercially available by Vidyo, Inc., to be a Control Unit 670 with an integrated Node Unit serving one camera. In fact, the system can have two such units, one acting as a Control Unit and the other as a simple Node Unit. This way, if the active Control Unit ceases to work, the other Node Unit can start operating as a Control Unit/Node Unit combination, thus providing fault tolerance.

The Control Unit 670 operates very similarly to an SVCS. For video and audio streams arriving to the Endpoint 600, the Control Unit 670 decides to which Node Unit 655 to send them (including which layers to include). Similarly, the Control Unit 670 activates each video and audio encoder in the various Nodes 650 so equipped, receives their coded video or audio streams, and transmits them to the connected SVCS (or other endpoint). The communication of the real-time streams between the two devices can be performed using standard RTP.

In one embodiment of the disclosed subject matter, the Node Units 655, the Control Panel 680 and the Control Unit 670 can automatically self-discover each other using the UPnP protocol (Universal Plug-and-Play, UPnP Forum, and also International Standard ISO/IEC 29341) and work as a cluster. UPnP allows devices to advertise their presence and the services that they offer to control devices on the network. Control devices in turn can send suitable control messages to the control URL for the service (provided in the service description), and express them in XML using SOAP (Simple Object Access Protocol, Word Wide Web Consortium/W3C). Other protocols, including custom ones, e.g., using Remote Procedure Calls (RPC), can also be used as is obvious to persons skilled in the art. The control of the communication between Node Units 655 and the Control Unit 670, including error resilience functions, is performed by a special Node Unit Protocol that is implemented using UPnP, and is discussed after the overall system architecture is presented. Note that this architecture allows Node Units 655 to be dynamically removed from, or added to, the system, even when communication is on-going (in real-time). This can be useful in certain applications and provides very high fault-tolerance.

The Control Unit 670 is also the connection point of the Endpoint 500 to SVCSs or directly to other endpoints (neither shown in this diagram). Similarly to the Node-to-Control Unit connection, in one embodiment of the disclosed subject matter the connection between the Control Unit 670 and any SVCS or other endpoint is performed over an IP-based network.

Finally, in one embodiment of the disclosed subject matter the Endpoint 600 is also connected to a Portal (indicated here to be outside this diagram). The Portal is a server function responsible for user management and authentication, as well as other system management functions, as discussed later on. The connection between the Endpoint 600 and the Portal is preferably over the IP network to which the Endpoint 600 is attached. Note that the Portal can also be integrated with an SVCS (or even with an Endpoint, in some product configurations); its operation remains the same.

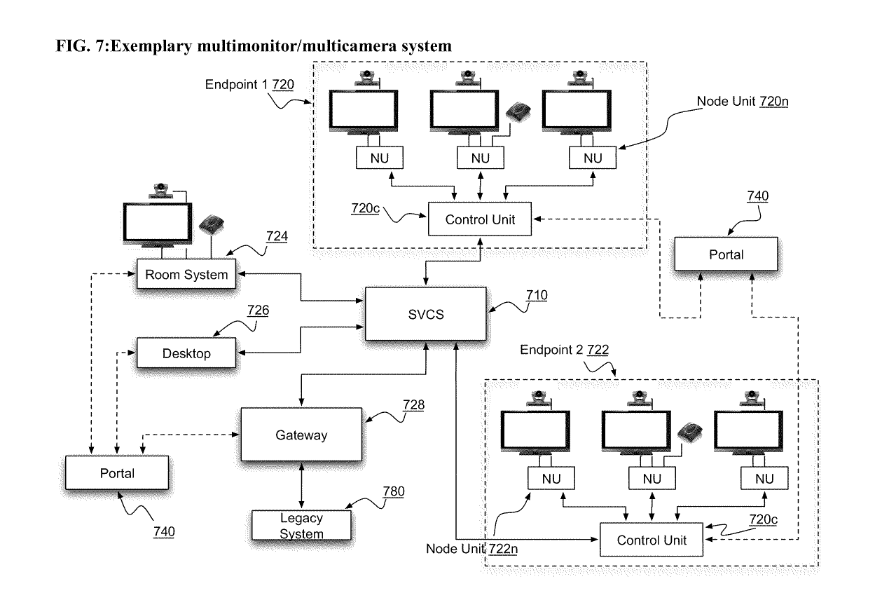

FIG. 7 depicts the an exemplary multimonitor/multicamera system with multiple types of endpoints, in one embodiment of the disclosed subject matter. The figure shows an SVCS 710 that interconnects a number of different types of endpoints. Although a single SVCS 710 is shown, it is noted that, in general, more than one SVCS can be associated with a connection since cascading can be used among SVCSs (i.e., more than one SVCS can be in the path from one endpoint to another). Cascading of SVCS does not affect the disclosed subject matter.

With continued reference to FIG. 7, there are two multimonitor/multicamera endpoints (Endpoint 1 720 and Endpoint 2 722), which are instances of the design shown in Endpoint 600 of FIG. 6. There is also a Room System 724 endpoint, which can be a typical SVC single encoder videoconferencing system such as the VidyoRoom HD-220 commercially offered by Vidyo, Inc., and a Desktop 726 endpoint which is an endpoint implemented in software and running on a general purpose computer, such as VidyoDesktop which is commercially offered by Vidyo, Inc. Finally, there is a Gateway 728 device which is used to interconnect a Legacy System 780 that may not support SVC. An example Gateway 728 device is the VidyoGateway commercially offered by Vidyo, Inc. The Legacy System 780 can be a room system, desktop software system, or, in fact, a legacy MCU. The Gateway 728 behaves as a regular SVC endpoint on its SVC connection, and as a legacy endpoint on its legacy connection; it performs transcoding of audio and video as appropriate, and also uses the appropriate signaling on each of its sides. For example, it can use H.323 to communicate with the Legacy System 780 and another protocol, possibly proprietary, to communicate to the SVCS 710, and transcode between H.264 SVC and H.263 for video, and between Speex and G.722 for audio.

The particular selection of endpoints and gateways is only used for purposes of illustration; any number of multimonitor/multicamera endpoints can be used, as well as any number of legacy endpoints or gateways, as is obvious to persons skilled in the art. At a minimum, it is assumed that at least one multimonitor/multicamera endpoint is present and at least one SVCS or other endpoint.

FIG. 7 also shows that all Endpoints/Gateways 720-728 are connected to Portals 740; two such portals are shown in the figure. As mentioned earlier, Portals provide server functions that are used to perform user management and authentication, as well as other system management functions. In one embodiment of the disclosed subject matter the VidyoPortal system can be used, commercially available by Vidyo, Inc. Some of the functions of a portal include: creation and management of users; assignment of users to groups and management of their permissions; creation and management of personal and public reservation-less meeting rooms; disabling of a personal room; creation of address book entries for predefined legacy devices (H.323 and SIP based); LDAP/Active Directory support for pass-through authentication, optional secure LDAP access, and multi-tenant support; load-balancing and license management across multiple SVCS devices. When multiple SVCS are used in a system, it is the Portal that decides how they are allocated to the various endpoints. It is noted that the Portal can be physically installed on the same system that provides the SVCS functionality, and—depending on product configuration—potentially in an Endpoint as well. This would be the case for offerings where a single device can be used to provide complete system functionality in a low cost bundle.

In one embodiment of the disclosed subject matter, all communication between endpoints, the SVCS 710, and Portals 740 is performed over a common IP network. The multimonitor/multicamera endpoints 720 and 722 are treated as any other endpoint by the SVCS and Portal, except that each one of them can produce more than one video stream. Functionally, for an SVCS (and a Portal), there is no difference if multiple video streams originate from the same endpoint or from different endpoints.

In one embodiment of the disclosed subject matter, the communication between Endpoints and the Portals 740 is performed using an Endpoint Management and Control Protocol (EMCP). These connections are shown with dashed lines in FIG. 7.

In one embodiment of the disclosed subject matter a protocol is used between SVCSs and Endpoints to indicate to an upstream device (i.e., a receiving SVCS to a transmitting endpoint, a receiving endpoint to a transmitting SVCS, or a receiving SVCS to a transmitting SVCS) which layers of each of the available sources to include in its transmission. In one embodiment of the disclosed subject matter the Conference Management and Control Protocol (CMCP) is used, described in commonly assigned U.S. Provisional Patent Application 61/384,634, “System and method for the control and management of multipoint conferences,” which is incorporated by reference herein in its entirety.

The fact that scalable video coding offers multiple resolutions on the same bitstream, as well as the fact that composition occurs on the receiving endpoint provides complete flexibility in implementing different layouts.

With continued reference to FIG. 7, two separate embodiments are illustrated, depending on how media flows from the Node Units of the multicamera/multimonitor endpoints 720 and 722 to the SVCS 710. In one embodiment, called the signaling plane control unit embodiment (or “signaling aggregation” embodiment), the Portal 740 to which the Endpoint 720 or 722 is connected is configured so that the endpoint is identified as an multimonitor/multistream endpoint. A connection request then is translated to N individual connections between the N Node Units (e.g., the three Node Units 720n) of the Endpoint and the SVCS (710). The N connections are automatically established through the Control Unit (720c) of the Endpoint. A potential drawback of this configuration is that N separate connections have to be made for each Endpoint. Although this does not affect the SVCS (the per-connection overhead is minimal—what matters is the packets/second load), it does require that N ports are opened on any firewall that may be used. This potential shortcoming is eliminated in the media plane control unit embodiment, described next. The Control Unit in this case behaves somewhat as a Portal, in that it is used to set up connections but it is not in the path of media.

In the media control unit embodiment (also referred to as “media aggregation” embodiment), all media flow from- and to- the Node Units is always performed through the Control Unit of each corresponding Endpoint. For Endpoint 1 720, this means that all media flow from- and to- the three Node Units 720n is performed through the Control Unit 720c. In this case the Control Unit acts more like an SVCS, or a cascaded SVCS, in that all media flows through it and it can make and implement decisions on which data to forward in either direction. The main advantage of the media control unit embodiment is that a single RTP session can be used for all media of the same type, thus simplifying firewall traversal and session setup processes. Also, any decisions that the Control Unit has to make with respect to sending a particular video stream to a particular Node Unit are implemented by the Control Unit itself, and do not have to be communicated to the SVCS, as with signaling only aggregation. Node Units are relatively simpler as well, since they only have to implement very basic signaling functionality. Finally, it can potentially offer a simpler and/or more safe implementation if media encryption is used. In the following it is assumed that the media aggregation is used.

In summary, with continued reference to FIG. 7, the multimonitor/multicamera endpoints are essentially mini-SVCS conferencing systems: the Control Unit behaves as an SVCS between the external world and the Node Units contained in the Endpoint. The Node Units, however, are not fully-fledged Endpoints, and hence do not talk directly to the SVCS (per the media aggregation embodiment). This also means that they do not run the CMCP protocol that normally operates between SVCSs and endpoints. Therefore, in order to facilitate the interworking between Node Units and Node Control Units, it is necessary to use a new control protocol. This Node Unit Protocol (NUP) protocol, implemented using UPnP as previously indicated, will allow the Control Unit to query its Node Units for their capabilities, inquire about their status, and instruct them to perform certain functions, such as to display a particular video stream to a particular display location. The protocol must also support event notification, so that the Control Unit can be notified by Node Units regarding changes in their status (e.g., termination, or change of a window size, speaker activation, even a request for packet retransmission in case of packet loss, etc.).

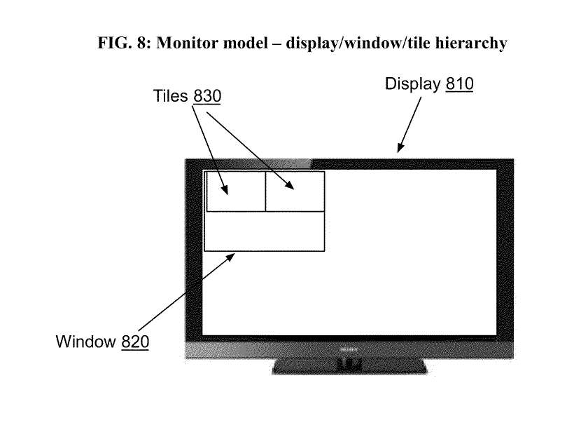

In order to fully control placement of videos on the multiple monitors, the Node Unit uses a tree-structured conceptual model of the monitor area comprised of a display (the entire monitor display area), windows, and tiles. The structure is shown in FIG. 8. Tiles are the smallest element to which video streams are decoded. Note that tiles do not have to be rectangular, as discussed later on.

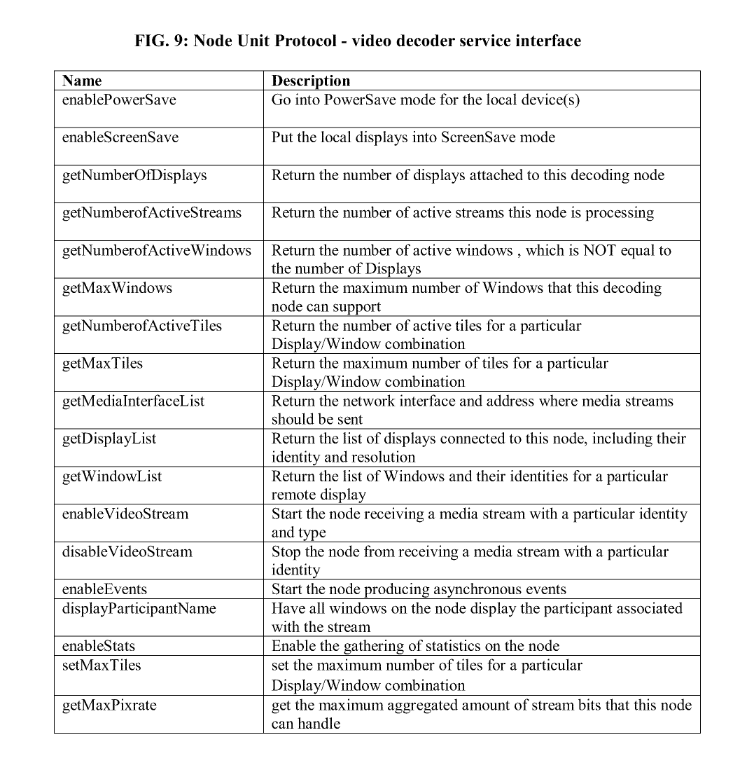

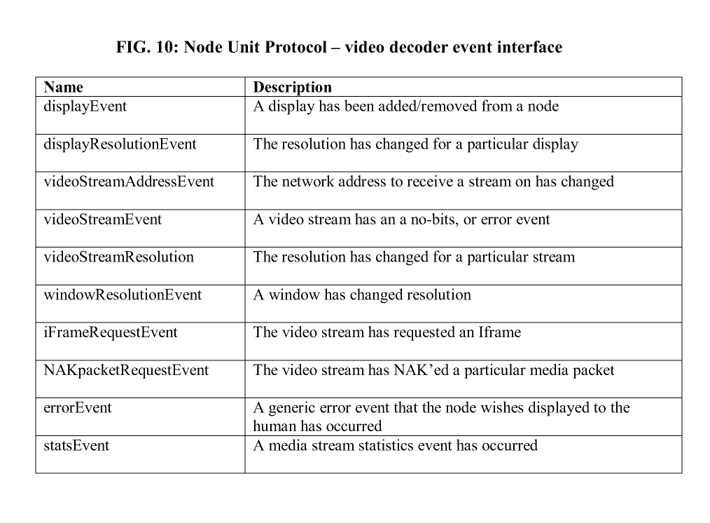

Example message definitions for the NUP are provided in FIG. 9, and example event definitions are provided in FIG. 10. In addition to management operations for displays, windows, and tiles, the video decoder event interface shown in FIG. 10 also includes a “NAKpacketRequestEvent”. In one embodiment of the disclosed subject matter, the “R packets” technique described in previously-cited International Patent Application Nos. PCT/US06/62569 and PCT/US08/50640 is used, with negative acknowledgments (“LR protection protocol using negative acknowledgments”). With reference to FIG. 7, such protocol operates, for example, between the Control Unit 720c of Endpoint 1 720 and the SVCS 710. Since the connection between the Control Unit 720c and its associated Node Units 720n is, in general, over a best-effort IP network, the case of packet losses in that connection need to be considered as well.

The “NAKpacketRequestEvent” event implements the negative acknowledgment in an identical way to the LR protection protocol, but this time carried over the NUP protocol. The R picture sequence indices can be carried over the standard RTP stream, using the optional Y bit of the PACSI header (with the associated optional TLOPICIDX and IDRPICID fields, and the S and E flags) in RFC 6190 (previously cited).

When a Control Unit 720c receives a “NAKpacketRequestEvent” event, it either retransmits the missing packet, if still available in its cache, or passes the negative acknowledgment upstream to the SVCS 710 (or whatever device happens to be connected upstream).

The main difference between single-camera systems and the multimonitor/multicamera systems is the fact that a multicamera source can be treated as a unit, and that a multimonitor system offers considerable flexibility in terms of how incoming video streams are to be displayed in the various monitors.

The spatial positioning of the video streams provided from a multicamera endpoint can have significance. For example, the relative positioning of each stream may need to be indicated (e.g., left, center, and right). This will enable a receiving endpoint to respect the spatial orientation and facilitate proper display. At a lower level, it can be desirable to only establish that streams are “linked”—in other words, they should be treated as a unit: if one is displayed, the other(s) should as well, and vice versa. For a camera, the system can even indicate its relative position from a known system location, as well as its vertical and horizontal angles (tilt/pan) and zoom factors. This information allows the receiver to know what the camera is looking at in the remote room.

It is also possible that the multiple video streams have no spatial orientation preference; for example, consider two cameras that take very close-up shots of two users. In this scenario, the relative spatial positioning may not matter.

The streams can have other attributes of significance. For example one of them can be marked as the loudest, or active, speaker. If the multiple cameras capture multiple people, it is not possible to infer (at least without some significant processing) which video corresponds to the active speaker. This information should therefore be provided by the endpoint itself. Proper tagging in this case can require that each camera has an associated microphone. This can also enable the system to provide spatial localization for audio, in that the active speaker's audio can be played back on the monitor where the video is shown. Such audio localization is also useful when a user is entering or leaving the conferencing session; the “chime” (or possibly a more complicated, text-to-speech driven announcement) that is played by the system should be played on the monitor (or near the monitor, if the monitor does not have speakers) where the particular user will be, or was, shown. This can ensure that the user's attention will be drawn to the right monitor.

Other attributes of interest can be geolocation, which, for example, can provide information about the physical location where the video streams originate (e.g., “New York Office”, or “Atlanta Airport”). The IP address where the video streams originally can be used to the same effect. Video resolution can also be an attribute of significance.

In order to better facilitate the organization of the layout on the remote size, and to attempt to preserve the physical characteristics of the room and the position of the participants, one embodiment of the disclosed subject matter also includes in each of the video streams it transmits, or in its signaling information, metadata that provides a set of attributes or tags.

Similarly, a receiving system can indicate to the sender the number, position, and size of its monitors. It is possible that during call setup the systems exchange these parameters so that they identify the best possible operating mode between them.

When the configuration of two communicating systems is different, it is possible for either the transmitter or the receiver to perform adaptation. For example, if a system is designed to transmit video that is supposed to be shown in three display monitors that are on the same plane, whereas a particular receiving room has its display monitors in an arc configuration, the sender or receiver could perform perspective correction operation on the video signals.

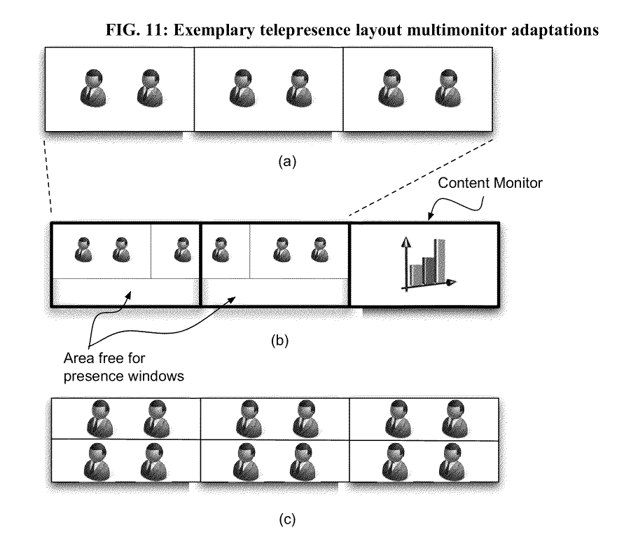

Assuming that multiple monitors are available to a single Node Unit, it is possible to decode and render video so that it spans more than one monitor. FIG. 11 shows some possible layout adaptations appropriate for telepresence-like layouts. FIG. 11(a) shows a typical 3/3/2 telepresence system layout. One monitor for content display can be allocated by shrinking the 3 telepresence streams to ⅔ of their original size, and displaying them using only 2 monitors as shown in FIG. 11(b). Note that the bottom ⅓ of the two left-most monitors is empty; that area can be used to fit “presence” windows, e.g., from participants that use 1/1/1 systems. The right-most monitor is allocated for content (e.g., to display computer slides). The particular layout requires that the decoded output of the middle video stream is split across two monitors (left and center); this can be easily implemented if both monitors are attached to the same Node Unit. If not, then either the video stream has to be transmitted to the two different Node Units, and appropriately cropped prior to display in each, or the original encoding has to be done in two sets of rectangular slices that each covers half of the picture, so that the Control Unit can then forward each slice set to the corresponding Node Unit.

Note that, with SVC, there is no need to perform downsampling of the three video signals by a factor of ⅔ in order to fit them to the two monitors. If spatial scalability with a ratio of 1.5 is used, low resolution versions can be directly obtained from the SVC bitstream. Similarly, for a 4/4/-system, the room can be fitted into two monitors using 2:1 spatial scalability without any processing. Other ratios can be more difficult to accommodate, since they are not directly supported by SVC's Scalable Baseline profile.

FIG. 11(c) shows a layout in which two 3/3/2 telepresence system rooms are displayed in a single set of 3 monitors. In this instance the video streams have been cropped in their upper and lower parts (one quarter of the picture height each), so that two sets can fit vertically on the monitors. Of course cropping can produce visual problems if the placement of the subjects is not appropriate within each frame.

It is evident from the preceding discussion that the traditional telepresence system layout has considerable limitations in terms of flexibility in combining video from different sources. In general, telepresence systems work best in symmetrical and point-to-point configurations.

Commonly assigned International Patent Application No. PCT/US09/046,758, “System and method for improved layout management in scalable video and audio communication systems,” incorporated by reference herein in its entirety, describes several techniques for performing layout management on a single monitor (or, more generally, a single rectangular display area), focusing particularly on the unique layout capabilities offered by SVC and the SVCS architecture.

With reference to FIG. 7, in one embodiment of the disclosed subject matter, we assume that each Node Unit 720n of a multimonitor/multicamera Endpoint 720 has been assigned a particular layout by its Control Unit 720c.

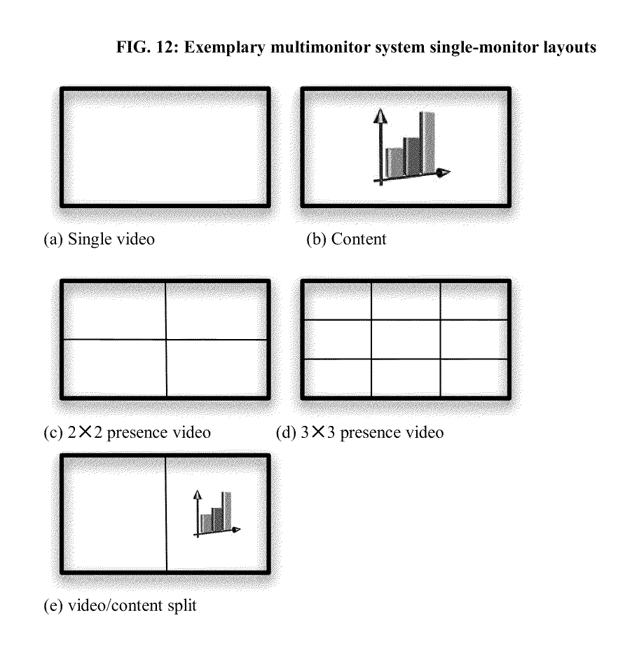

FIG. 12 depicts exemplary single monitor layouts to be used by a multimonitor system. With reference to the display/window/tile hierarchy shown in FIG. 8, it is assumed here that each display (monitor) has a set of rectangular windows, and that each window contains a single tile that covers the window in its entirety. In other words, in the following, each rectangular window is associated with a single video stream.

In FIG. 12(a) a single video stream is rendered into the entire monitor. In FIG. 12(b) the content stream is rendered into the entire monitor. In FIG. 12(c) it is shown a 2-by-2 presence layout with 4 windows. Assuming that the native video resolution covers the entire monitor, then video would be shown here in each window in half its original resolution. In general, however, the resolution of the encoded video can vary among the different endpoints that may participate in the session. Therefore, no assumptions should be made about the resolution of the video that is assigned to each of the windows. It is up to the Control Unit and Node Unit to decide if a layer should be dropped, or if scaling and/or cropping should be applied. The operation here is similar to the one described in previously cited International Patent Application Nr. PCT/US09/046,758, with the Node Unit playing the role of the endpoint and the Control Unit playing the role of the SVCS. For example, if the Node Unit displays a video in a small window, the Control Unit can transmit only the lower spatial layer, depending on the size of the window and the resolution of the various spatial layers. The Control Unit can use upper limits on the maximum number of pixels or maximum Kbps that a particular Node Unit can sustain, to make further optimizations of layer selection.

With continued reference to FIG. 12, in FIG. 12(d) a 3-by-3 presence layout is shown with 9 windows. Finally, in FIG. 12(e) a display is shown as vertically split, showing both video and content. Again, depending on the source resolution and the display resolution, it can be preferable to use base spatial layer, downsample, or crop as appropriate, and as determined by the Node Unit.

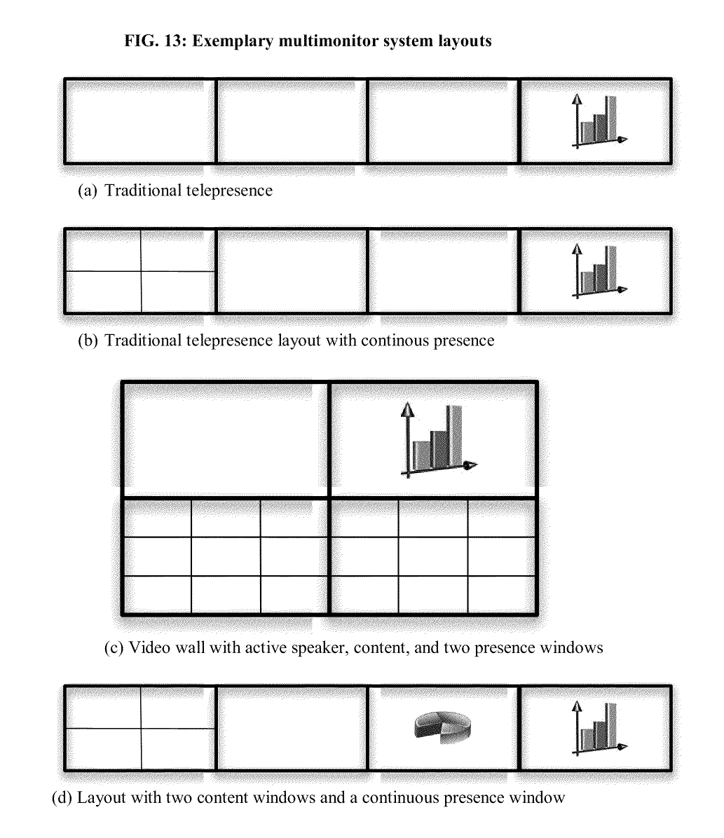

These single monitor layouts can now be combined in multimonitor systems in various ways. FIG. 13 shows several examples. In FIG. 13(a) a traditional telepresence system layout is shown, with three video monitors and one for content. In FIG. 13(b) one of the monitors has been switched to offer continuous presence for four participants.

FIG. 13(c) shows a video wall in which one monitor is allocated for the active speaker, one of content, and two are allocated for continuous presence for 18 participants. This particular configuration can also be used to connect 6 telepresence rooms that use a 3/3/-configuration. The lower monitors display the 6 rooms by placing the three videos of each room in a window row of each monitor. The active speaker monitor displays the active speaker, which can be in any one of the 18 video streams provided. The Control Unit of the Endpoint will select which incoming video stream is the one corresponding to the active speaker, and forward (a duplicate) of the video to the associated Node Unit. In this example the active speaker can also be shown in the bottom views.

FIG. 13(d) shows a layout with two separate content monitors and a continuous presence monitor, together with a single-view monitor. This allows content from two different applications and/or participants to be simultaneously shown on the monitors. Clearly, with the disclosed subject matter, any number of monitors can be allocated to display content. Although in the examples of FIG. 13 all monitors are shown to have the same size and resolution, this does not have to be the case. Indeed, the system does not need to make any assumptions regarding the actual monitor sizes and resolutions.

The determination of the active speaker can be done by appropriate tagging of the associated video and audio streams with a standardized audio intensity measure. This way the Control Unit can easily make the decision without any audio processing.

Note that the system can transition from layouts dynamically, to accommodate changes in the system. For example, it could transition from layout FIG. 13(a) to (b) as more participants are added to the system. Another example is when a new Node Unit comes on-line or is stops working; the Control Unit can detect that and immediately switch to the appropriate layout configuration with more, or less, monitor(s).

Contrary to traditional telepresence systems, in a general multimonitor/multicamera system videos can be assigned to windows and monitors at will. Use of SVC for the video representation, coupled with the selective forwarding capability of a Node's Control Unit and of the SVCS, any desirable layout (including those of traditional telepresence systems) can be easily implemented, including the implementation of layout transitions.

Through the use of tagging, which is used above to implement active speaker selection, other interesting layout management strategies can be implemented. For example, a monitor can be marked to always show a particular participant (e.g., the CEO of a company). Using geolocation tagging (or the IP address of the video sources), participants from the same geographical location can be forced to always be shown in windows that are physically next to each other, to further enhance the perception of their physical proximity. By linking streams to each other, they can be shown in particular configurations in their respective windows (for example, one to the left of the other).

Finally, operations such as duplication (“duping”) or mirroring can also be easily implemented. In the first case a video stream is shown in more than one window, and in the second case there is duplication but with a reflection of the picture along the vertical axis (as with a regular mirror). This can be used for creative effect in large monitor walls. In one embodiment of the disclosed subject matter, the Control Panel of the Endpoint can allow the user to select the desired layout configuration and switch between different ones in real-time and on the fly. It is also possible that identical functionality is provided through some other interface to the Control Unit, which manages the layout, as is obvious to persons skilled in the art. Additional functionalities that the system can provide include swapping streams between windows, “pinning” streams to particular windows so that any automatic layout determination algorithm does not modify their window allocation, or moving streams from one window to another. The system can also offer as an option to include a text overlay in each video window of the name of the associated endpoint.

An additional function that can be provided by the Control Unit is an “identify” operation; when triggered, the Control Unit instructs each Node equipped with one or more monitors to display an integer number on the monitor. This way the user can easily identify which monitor number is assigned to which physical monitor in the system. Alternatively, the Control Panel, or an alternative interface to the Control Unit, could provide the ability to show a particular uniform color on a monitor selected on its user interface. This would also allow the user to identify the particular monitor.

All these layout management strategies and operations are simple packet forwarding decisions that are made at the Control Unit of the multimonitor/multicamera endpoint, and require no signal processing. In one embodiment of the disclosed subject matter, the Control Unit establishes a desired layout with the various Node Units. Video-to-window allocation within the available monitors is based on prioritization attributes (e.g., active speaker) and respecting stream placement constraints (e.g., stream linking, telepresence grouping, geolocation).

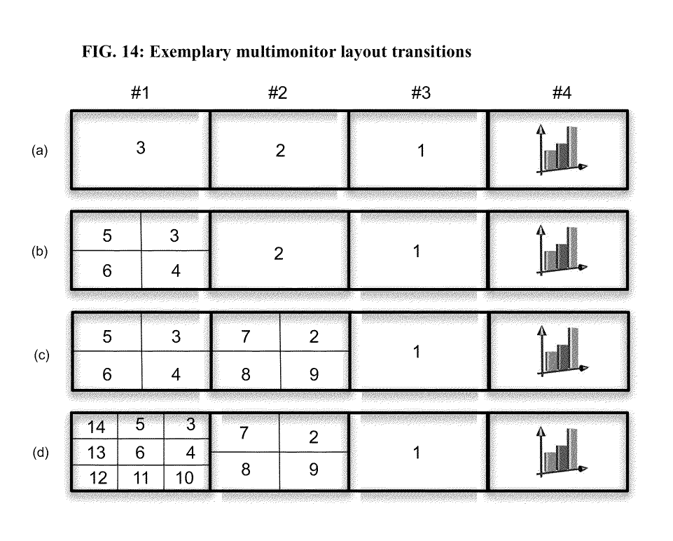

FIG. 14 shows an exemplary set of layout transitions using a four monitor configuration. The Control Unit initially sets the Node Units to display blank screens (or a manufacturer logo) on all monitors. As the first three users join the session, their videos are allocated to each one of the video monitors (#1 through #3) through their associated Node Units. The numbers inside the monitor windows show the order of participant placement. The content monitor (#4) is marked to be used exclusively for presentations, if any. When a fourth user joins the session, the Control Unit instructs the Node Unit associated with monitor #1 to switch to a 2-by-2 layout, thus transitioning to the layout shown in FIG. 14(b). It then allocates the existing participant (3) and the newcomer (4) to one of the windows in that monitor; the other two free windows can show manufacturer logos or be blank. When all 4 positions are filled in monitor 1 (6 participants in total), then the Control Unit instructs the Node Unit associated with monitor #2 to switch to a 2-by-2 layout as well, as shown in the layout of FIG. 14(c). When the 10^{th} participant is introduced, all windows in the layout of FIG. 14(c) are occupied, and the system switches to the layout shown in FIG. 14(d), in which monitor #1 has switched to a 3-by-3 layout. This layout can be used with up to 14 participants. The process can continue with additional layout variations, e.g., switching monitor #2 to a 3-by-3 layout and so on. More participants can be added, or, as is obvious to persons skilled in the art, elect different layout transitions or combinations. The reverse order of participant placement and layout selection can be used when participants leave the session.

Assuming that monitor #3 is allocated to be used for the active speaker, then the Control Unit will perform stream swapping as necessary so that the active speaker is always shown on monitor #3. For example, with reference to FIG. 14(d), if participant 6 becomes the active speaker, as determined by the tags associated with the streams, then the Control Unit will transmit the video associated with participant 1 to the Node Unit associated with monitor #1 and replace it in monitor #3 with the video stream of participant 6.

As shown, the benefits associated with SVCS can carry over to the environment of the multimonitor/multicamera endpoint. This is because the scalable nature of the coded representation of the video signal enables the elimination of signal processing for most of the useful system operations.

In commercial systems, an important consideration is how the system is licensed for use. The typical model used in videoconferencing is the concept of a “port.” A port in a legacy system is associated with a physical port on an MCU, and implies use of DSP resources. In an SVCS architecture, the concept of a port can be replaced by that of a “line,” i.e., a form of soft-licensing associated with connections to the SVCS. Line licensing is performed at the Portal, so that a set of line licenses can be used across a set of SVCSs. This allows, for example, to implement “follow the sun” strategies for license management, and thus use the same licenses in the US, Europe, and Asia, but at different times of the day. In a multimonitor/multicamera endpoint setting where a large number of monitors or camera can be involved, it is advantageous to be able to specify licensing levels that depend on any of the following: number of streams per monitor; number of streams per node; number of streams per monitor; number of cameras; resolution limits; number of monitors; or total bandwidth. License management is performed at the Portal, when connections are set up.

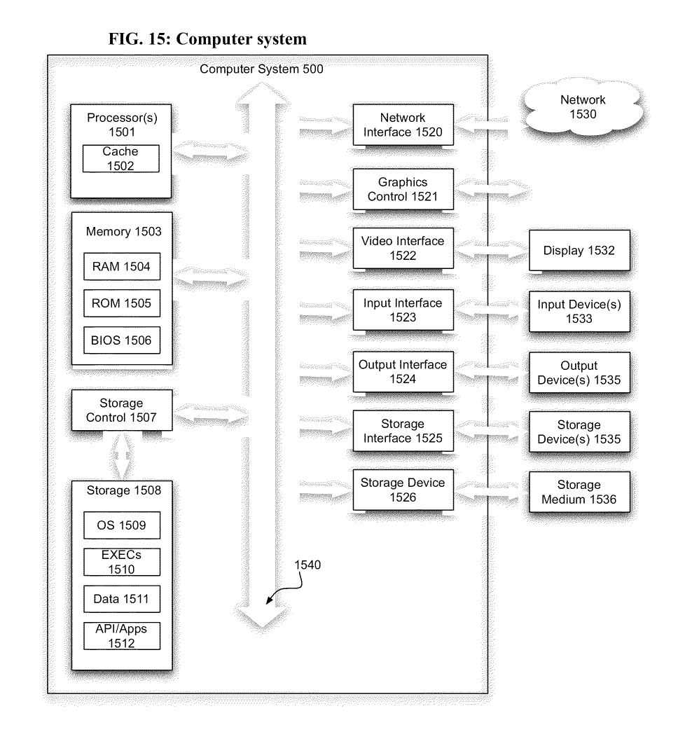

The methods for scalable video communication using multiple cameras and multiple monitors described above can be implemented as computer software using computer-readable instructions and physically stored in computer-readable medium. The computer software can be encoded using any suitable computer languages. The software instructions can be executed on various types of computers. For example, FIG. 15 illustrates a computer system 1500 suitable for implementing embodiments of the present disclosure.

The components shown in FIG. 15 for computer system 1500 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 1500 can have many physical forms including an integrated circuit, a printed circuit board, a small handheld device (such as a mobile telephone or PDA), a personal computer or a super computer.

Computer system 1500 includes a display 1532, one or more input devices 1533 (e.g., keypad, keyboard, mouse, stylus, etc.), one or more output devices 1534 (e.g., speaker), one or more storage devices 1535, various types of storage medium 1536.

The system bus 1540 link a wide variety of subsystems. As understood by those skilled in the art, a “bus” refers to a plurality of digital signal lines serving a common function. The system bus 1540 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 1501 (also referred to as central processing units, or CPUs) optionally contain a cache memory unit 1502 for temporary local storage of instructions, data, or computer addresses. Processor(s) 1501 are coupled to storage devices including memory 1503. Memory 1503 includes random access memory (RAM) 1504 and read-only memory (ROM) 1505. As is well known in the art, ROM 1505 acts to transfer data and instructions uni-directionally to the processor(s) 1501, and RAM 1504 is used typically to transfer data and instructions in a bi-directional manner. Both of these types of memories can include any suitable of the computer-readable media described below.

A fixed storage 1508 is also coupled bi-directionally to the processor(s) 1501, optionally via a storage control unit 1507. It provides additional data storage capacity and can also include any of the computer-readable media described below. Storage 1508 can be used to store operating system 1509, EXECs 1510, application programs 1512, data 1511 and the like and is typically a secondary storage medium (such as a hard disk) that is slower than primary storage. It should be appreciated that the information retained within storage 1508, can, in appropriate cases, be incorporated in standard fashion as virtual memory in memory 1503.

Processor(s) 1501 is also coupled to a variety of interfaces such as graphics control 1521, video interface 1522, input interface 1523, output interface 1524, storage interface 1525, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 1501 can be coupled to another computer or telecommunications network 1530 using network interface 1520. With such a network interface 1520, it is contemplated that the CPU 1501 might receive information from the network 1530, or might output information to the network in the course of performing the above-described method. Furthermore, method embodiments of the present disclosure can execute solely upon CPU 1501 or can execute over a network 1530 such as the Internet in conjunction with a remote CPU 1501 that shares a portion of the processing.

According to various embodiments, when in a network environment, i.e., when computer system 1500 is connected to network 1530, computer system 1500 can communicate with other devices that are also connected to network 1530. Communications can be sent to and from computer system 1500 via network interface 1520. For example, incoming communications, such as a request or a response from another device, in the form of one or more packets, can be received from network 1530 at network interface 1520 and stored in selected sections in memory 1503 for processing. Outgoing communications, such as a request or a response to another device, again in the form of one or more packets, can also be stored in selected sections in memory 1503 and sent out to network 1530 at network interface 1520. Processor(s) 1501 can access these communication packets stored in memory 1503 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

As an example and not by way of limitation, the computer system having architecture 1500 can provide functionality as a result of processor(s) 1501 executing software embodied in one or more tangible, computer-readable media, such as memory 1503. The software implementing various embodiments of the present disclosure can be stored in memory 1503 and executed by processor(s) 1501. A computer-readable medium can include one or more memory devices, according to particular needs. Memory 1503 can read the software from one or more other computer-readable media, such as mass storage device(s) 1535 or from one or more other sources via communication interface. The software can cause processor(s) 1501 to execute particular processes or particular parts of particular processes described herein, including defining data structures stored in memory 1503 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosed subject matter. It will thus be appreciated that those skilled in the art will be able to devise numerous systems and methods which, although not explicitly shown or described herein, embody the principles of the invention and are thus within the spirit and scope of the invention.

What is claimed is:

1. A video communication system for transmitting one or more video signals obtained from zero or more cameras and receiving a plurality of video signals over a communication network for display on a plurality of monitors, wherein the video signals are scalably coded into layers including a base layer and one or more enhancement layers, the system comprising:
one or more node units comprising video decoders and encoders, to which the plurality of monitors and cameras are connected;
a control unit attached to the communication network and connected to the one more node units over a second communication network;
wherein the control unit is configured to selectively forward a video signal layer received over the communication network to the one or more node units over the second communication network for decoding and display in the plurality of monitors, and selectively forward over the communication network a video signal layer received encoded from the one or more node units over the second communication network.

2. The system of claim 1, wherein the one or more node units and the control unit dynamically discover each other and establish their connections over the second communication network.

3. The system of claim 1, wherein the control unit instructs the one or more node units to use a particular layout for display of the plurality of video signals on their connected monitors.

4. The system of claim 3, wherein the control unit dynamically instructs one or more of the one or more node units to modify its layout as a result of a change in system condition.

5. The system of claim 4, wherein the system condition includes event notifications communicated to the control unit by the one or more node units.

6. The system of claim 3, wherein the selection by the control unit of the particular layout to be used by the one or more node units is determined by an algorithm that depends on attributes or tags provided in the plurality of video signals received over the communication network.

7. The system of claim 1, wherein the lowest temporal layer of the video signals is protected during transmission over the second communication network using R picture loss detection and retransmission with negative acknowledgments.

8. A method for transmitting over a communication network one or more video signals obtained from zero or more cameras connected to one or more node units, and receiving a plurality of video signals over the communication network for display on a plurality of monitors connected to the one or more node units, wherein the one or more node units are connected to a control unit over a second communication network, the control unit being attached to the communication network, the method comprising at the control unit:
for transmission, obtaining a scalable video signal layer from the one or more node units, wherein the video signal is coded in layered format including a base layer and one or more enhancement layers;
selecting one or more layers of the coded video signal;
forwarding the selected one or more layers to the communication network; and
for reception, obtaining a scalable video signal layer fro the communication network, wherein the video signal is coded in layered format including a base layer and one or more enhancement layers;
selecting one or more layers of the coded video signal;
forwarding the selected one or more layers to the one or more node units for decoding and display on the plurality of monitors.

9. The method of claim 8, wherein the one or more node units and the control unit dynamically discover each other and establish connections over the second communication network.

10. The method of claim 8, further comprising:
instructing the node units to use a particular layout for the display of video signals forwarded to them on their connected monitors.

11. The method of claim 10, further comprising:
dynamically instructing one or more of the one or more node units to modify its layout as a result of change in system condition.

12. The method of claim 11, wherein the system condition includes event notifications communicated to the control unit by the one or more node units.

13. The method of claim 10, wherein the selection by the control unit of the particular layout to be used by the one or more node units is determined by an algorithm that depends on attributes or tags provided in the plurality of video signals received over the communication network.

14. The method of claim 8, wherein the R picture loss detection is used to protect the lowest temporal layer of the video signals during transmission over the second communication network, the method further comprising:
requesting retransmission with negative acknowledgment upon detection of a lost R picture or portion thereof.

15. Computer readable media comprising a set of instructions to perform the steps recited in at least one of claims 8-15.
